(19) United States
(12) Patent Application Publication
(10) Pub. No.: US 2006/0012462 A1
(43) Pub. Date: Jan. 19, 2006

(54) Remote control system

(75) Inventors: Kentaro Teshima, Kariya-city (JP); Yuji Kato, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/159,359

(22) Filed: Jun. 23, 2005

(30) Foreign Application Priority Data
Jul. 14, 2004 (JP) 2004-207625

(51) Int. Cl. G05B 19/00

(52) U.S. Cl. 340/5.61; 340/5.62; 340/5.72

(57) ABSTRACT

A door lock system for controlling access to an automobile includes at least one transmitter in the door of the automobile for transmitting a request signal, a portable device for transmitting a response signal having an ID code in response to the request signal, a receiver for receiving the response signal, and a controller for controlling a lock in the door based on an identity of the ID code. The transmitter and the receiver intermittently operate to respond to a user of the portable device.

### CROSS REFERENCE TO RELATED APPLICATION

This application is based on and claims the benefit of priority of Japanese Patent Application No. 2004-207625 filed on Jul. 14, 2004, the disclosure of which is incorporated herein by reference.

### FIELD OF THE INVENTION

The present invention generally relates to a door lock system, and more specifically to a door lock system having a portable device for controlling a door lock.

### BACKGROUND OF THE INVENTION

A conventional door lock system uses a portable device for remotely controlling a door lock condition based on a result of identification (ID) code matching through a bidirectional communication between the portable device and a station unit on, for example, an automobile. This type of door lock system sets a detection area for detecting the portable device, and recognizes an approaching portable device by transmitting a request signal to the portable device in a predetermined interval of time. In this manner, the door lock system continuously recognizes an approaching user having the portable device, a user getting into the automobile or a user getting out of the automobile.

A response of the door lock system to the user is described in detail. That is, the door lock system responds to the user having the portable device in the detection area with the request signal for requesting a response signal having an ID code. The station unit of the door lock system on the automobile determines if the ID code in the response signal from the portable device coincides with a registered ID code. The station unit issues a control signal to door locks in the doors to put the door locks in a stand-by mode if the ID code in the response signal coincides with the registered ID code. The door lock(s) will be unlocked upon detecting an operation on a door handle when the user touches the door handle while the door lock is in a stand-by mode.

The detection area of the door lock system follows the movement of the user. That is, the detection area is switched from an inside of the automobile to an outside when the user gets out of the automobile after turning off an engine. In this case, the door lock(s) will be locked, for example, upon detecting the operation on a door lock switch disposed on the door handle.

The door lock system described above enables the user to lock and unlock the door locks without operating the portable device. An operation-less locking and unlocking feature of the door lock system facilitates usefulness of the door lock system.

The operation-less locking and unlocking feature of the door lock system decreases a battery life by intermittently transmitting the request signals in a period of parking while facilitating its usefulness. The feature may cause a rundown of the battery when the automobile is parked for an extended period of time. Some door lock system uses a longer interval for transmitting the request signals depending on an elapsed time from parking to extend the battery life while the automobile is parked.

However, simply using the longer interval for transmitting the request signals may cause a delayed detection of the approaching user. Delayed detection may cause a decreased operability of the door lock system such as a delay for unlocking the door lock when the user touches on the door handle.

Further, the door lock(s) may be controlled by a locking/unlocking operation on the portable device (a wireless key feature) as well as an ID code matching by a smart key feature. The door lock system having both features has to be intermittently in a signal reception mode for promptly responding to the locking/unlocking operation on the portable device at any time.

However, the user tends to use only one feature of the door lock system. Therefore, activating a less-used feature of the door lock system may simply cause inconvenience for the user by, for example, consuming the battery in vain.

### SUMMARY OF THE INVENTION

In view of the above-described problems, it is an object of the present invention to provide a door lock system having an advantage in energy consumption feature without sacrificing operability.

It is another object of the present invention to provide a door lock system having an alternative of door lock control features, that is, a feature based on a bi-directional communication between a portable device and a station unit, and a feature base on a user operation on the portable device for transmitting a signal to a station unit, with a reduction of energy consumption by preventing activation of useless operation on the station unit.

According to the present invention, a door lock system for controlling a door lock includes a transmitter in each of a plurality of doors of a vehicle for transmitting a request signal, a portable device for transmitting a response signal having an ID code responding to the request signal, a receiver for receiving the response signal, a controller for controlling a lock in the door based on an identity of the ID code. The transmitter of the door lock disposed in each of the doors of the automobile controls transmission of the request signal based on access to each door.

The user having the portable device usually approaches the door for a driver's seat to get into the automobile. Therefore, access to each of the doors of the automobile is different in frequency. Further, the transmitter in each door transmits the request signal in different intervals because of the difference of access to each door. Thus, the transmitter in each door may be controlled to transmit the request signal differently from other transmitters, taking advantage of the difference of access to each door, to reduce energy consumption without sacrificing operability.

The door lock system of the present invention may record a history of use of each transmitter to control the interval of transmitting the request signal from the transmitter. The transmitter transmitting the request signal that causes the portable device to send the response signal is identified and recorded in the door lock system. The transmitter in each door transmits the request signal in different manner based on the history of recorded use, that is, one transmitter transmits the request signal more frequently than the other transmitter. In other words, the transmitter in frequent use is controlled to transmit the request signal more frequently than the transmitter in less frequent use. The door lock system controls the transmitters in each door in the above-described manner.

The user of the portable device may approach the door for the driver's seat, the door for a passenger's seat or the door for either of rear seats. The door lock system having the history of use controls each transmitter for responding to the approaching portable device according to the history of use, that is, a frequency of access. The door lock system prevents deterioration of operability by increasing transmission frequency of the request signal when the user approaches the door of frequent access. Further, the energy consumption by the door lock system is decreased by decreasing the frequency of transmitting the request signal from the less frequently used transmitter.

The frequency of transmitting the request signal may be stepwise, such as a high frequency transmission by using a first frequency, and a low frequency transmission by using a second frequency. The transmission of the request signal from the transmitter in rare use may be stopped.

The transmitter in the door preferably transmits the request signal upon receiving an input from the user of the portable device without having the response signal from the portable device. That is, the transmitter in, for example, the door for the driver's seat responds to the input to a switch on a door handle of the driver's seat from the user, and transmits the request signal.

The user of the portable device may approach the door of less frequent use. In that case, the approaching portable device may not be detected when the frequency of transmission of the request signal is decreased based on the history of use. The user can be detected when he/she reaches the door by an above-described scheme of operation.

The door lock system of the present invention may further facilitate the operability of the portable device in the following manner. That is, the portable device may use a first signal and a second signal for controlling the door lock. The portable device transmits the first signal upon receiving the input from the user, and transmits the second signal in response to the request signal from the station unit disposed on the automobile. The station unit intermittently transmits the request signal to the portable device, and intermittently prepares to receive the first signal with a readiness for receiving the second signal in synchronization with the transmission of the request signal. The station unit records use of the first and second signal by the user, and controls the frequency of reception operation for receiving each of the first signal and the second signal. That is, the frequency for receiving the first signal by intermittently turning on the station unit or a reception part of the unit, and the frequency of transmission of the request signal from the station unit accompanied by readiness for receiving the second signal in response to the request signal, are individually controlled based on the recorded use of the signals.

The door lock system of the present invention uses an above-described scheme of operation to suitably operate the part of the station unit in less frequent use for suppressing energy consumption.

### BRIEF DESCRIPTION OF THE DRAWINGS

Other objects, features and advantages of the present invention will become more apparent from the following detailed description made with reference to the accompanying drawings, in which:

FIG. 1 is a block diagram of a door lock system in an embodiment of the present invention;

FIG. 2 is a flowchart of a process of detecting operation while an automobile is parked in a first embodiment of the present invention; and

FIG. 3 is a time chart of request signals transmitted from a transmitter in each door of the automobile;

FIG. 4 is a time chart of request signals transmitted from a transmitter in each door of the automobile;

FIG. 5 is a block diagram of a door lock system in the second embodiment;

FIG. 6 is a flowchart of a process of detection operation while the automobile is parked in a second embodiment of the present invention;

FIG. 7A is a time chart of receiver operation for receiving a wireless key signal and a response signal;

FIG. 7B is a time chart of receiver operation for receiving a wireless key signal less frequently than the operation shown in FIG. 7A; and

FIG. 7C is a time chart of receiver operation for not receiving a wireless key signal.

### DETAILED DESCRIPTION OF THE PREFERRED EMBODIMENTS

A first embodiment of the present invention is described with reference to the drawings.

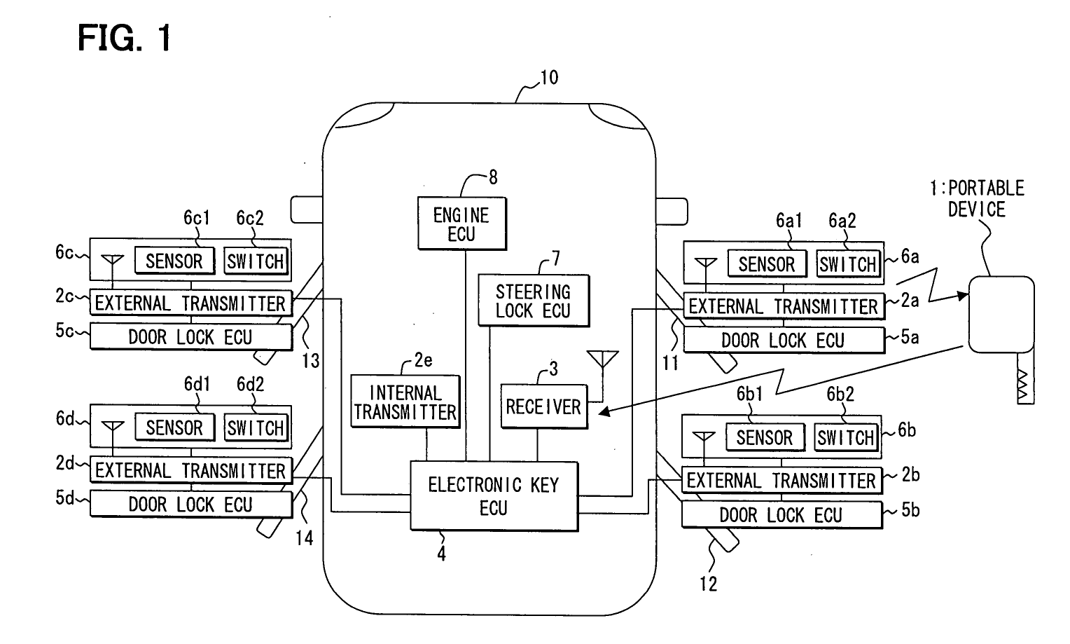

FIG. 1 shows a block diagram of a door lock system in the first embodiment. The door lock system includes a portable device (an electronic key) 1 and an electronic key ECU 4 to control lock/unlock operation of the door locks in each door based on a bidirectional communication for transmitting an ID code. The electronic key ECU 4 also controls steering lock condition and engine operation for improved security of an automobile 10.

The door lock system also includes a receiver 3 for receiving signals from the portable device 1 and is electrically connected to a steering lock ECU 7 and an engine ECU 8 as shown in FIG. 1.

The automobile 10 includes external transmitters 2a to 2d in doors 11 to 14 and an internal transmitter 2e in an inside of the automobile 10. The transmitters 2a to 2e transmit a request signal based on a transmission signal from the electronic key ECU 4. The electronic key ECU 4 sends the transmission signal to the external transmitters 2a to 2d for transmitting the request signal when the automobile 10 is parked with the doors 11 to 14 locked and an engine of the automobile 10 stopped. Coverage of the request signal is set, for example, to approximately 0.7 to 1.0 m from the automobile 10. Therefore, a user having the portable device 1 is detected in detection areas around the doors 11 to 14 of the automobile 10. The detection area is formed based on the reach of the coverage of the request signal.

The detection area of the internal transmitter 2e is used to detect the portable device 1 in the automobile 10 in occasions such as the door 11 for a driver's seat is operated, the engine is started, a door lock switch (described later) is operated to lock the door or the like.

The portable device 1 receives the request signal from the transmitters 2a to 2e, and transmits a response signal with the ID code and the like generated in a signal circuit in response to the request signal.

Communication between the portable device 1 and the transmitters 2a to 2d is conducted in the following manner. In the description, the communication between the portable device 1 and the transmitter 2a is explained as an example.

The portable device 1 “wakes up” from sleep condition when a first request signal for activating the signal circuit in the device 1 is transmitted from the transmitter 2a to the device 1. The device 1 sends back an acknowledge signal (ACK signal) as a first response signal in response to the request signal. The transmitter 2a transmits a second request signal with a vehicle-specific ID code for each body of the automobile 10 when the receiver 3 receives the ACK signal. The device 1 sends back the ACK signal again as a second response signal when the ID code is identical to a code in the device 1.

The transmitter 2a transmits a third request signal having a transmitter-specific code upon receiving the ACK signal to the second request signal. The device 1 sends back a third response signal having a response code made from the transmitter-specific code in addition to the vehicle-specific ID code. The communication between the device 1 and the transmitter 2a is aborted when the device 1 does not respond to the first and second request signals from the transmitter 2a.

The response signal is used to identify which transmitter is responding because the response signal includes a transmitter-specific code. The electronic key ECU 4 identifies which transmitter triggered the response signal by transmitting the request signal to the portable device 1.

The receiver 3 is disposed in the inside of the automobile 10 and receives the response signal from the device 1. The receiver 3 outputs a reception signal to the electronic key ECU 4 when it receives the response signal. The electronic key ECU 4 checks the ID code in the response signal with registered ID codes for identification.

Door lock ECUs 5a to 5d are disposed in the doors 11 to 14 to lock and unlock the doors 11 to 14, or to put the doors 11 to 14 in an unlock standby condition that unlocks the doors 11 to 14 when the user of the portable device 1 touches on door handles attached outside on the doors 11 to 14. The door lock ECUs 5a to 5d are controlled by a control signal from the electronic key ECU 4.

The electronic key ECU 4 determines a location of the user of the portable device 1 based on the response code when the received ID code and the registered ID code is identical. The electronic key ECU 4 outputs the control signal to one of the door lock ECUs 5a to 5d to put one of the doors 11 to 14 close to the located user in the unlock standby condition when the user is located outside of the automobile 10. One of the doors 11 to 14 close to the user is put in the unlock standby condition by one of the door lock ECUs 5a to 5d.

The door 11 is put in the unlock standby condition by the door lock ECU 5a, for example, when the user of the device 1 is located close to the door 11. The other doors 12 to 14 are kept locked during the operation described above.

Door handles 6a to 6d in the doors 11 to 14 have touch sensors 6a1 to 6d1 for detecting that the user of the device 1 is touching the door handle. The door handles 6a to 6d also have door lock switches 6a2 to 6d2 in a form of push switch. The door lock switch 6a2 to 6d2 locks the doors 11 to 14 when the ID code is identified as valid. The door handles 6a to 6d serves as antennas of the transmitters 2a to 2d.

One of the door lock ECUs 5a to 5d sends information on detection of the user of the device 1, who is touching one of the door handles 6a to 6d by using touch sensors 6a1 to 6d1, to the electronic key ECU 4 when one of the doors 11 to 14 is put in the unlock standby condition based on the control signal from the electronic key ECU 4. Then, the electronic key ECU 4 controls all of the doors 11 to 14 to be unlocked. That is, the doors 11 to 14 are unlocked by the electronic key ECU 4 when the user of the device 1 performs door open operation.

More practically, the doors 11 to 14 are unlocked upon detecting the user by the touch sensor 6a1 when the door 11 is in the unlock standby condition. The doors 11 to 14 are not unlocked when the touch sensors 6b1 to 6d1 detects other user who does not carry the portable device 1. This is because the doors 12 to 14 are not in the unlock standby condition when touch sensors 6b1 to 6d1 detects the other user.

The door open operation may be manually detected as a pull operation on the door handles 6a to 6d instead of signals from the touch sensors 6a1 to 6d1. The door handles 6a to 6d may have unlock buttons disposed thereon for detecting the door open operation. The doors 11 to 14 may be put in the unlock standby operation upon identifying the ID code.

The door lock system in the present embodiment is connected to the steering lock ECU 7 and the engine ECU 8 for improved security of the automobile 10. The electronic key ECU 4 controls the steering lock ECU 7 and the engine ECU 8 by sending the control signal. That is, a steering lock is turned on and off, and/or an engine of the automobile 10 is put in a ready-to-start condition or an immobilized condition.

The electronic key ECU 4 uses the bidirectional communication through the transmitter 2e and the receiver 3 to confirm the ID code when the user of the portable device 1 enters into the automobile 10 by opening and closing one of the doors 11 to 14. The electronic key ECU 4 also responds to confirmation from the steering lock ECU 7 when the steering lock ECU 7 requests confirmation upon detecting operation of an engine switch on the automobile 10. The electronic key ECU 4 sends a permission to unlock the steering to the steering lock ECU 7 when the ID code is identified. The steering lock ECU 7 unlocks the steering upon receiving the permission. The electronic key ECU 4 simultaneously sends permission to start the engine to the engine ECU 8. In this manner, the user of the portable device 1 can unlock the door of the automobile and can start the engine without explicitly operating the portable device.

The electronic key ECU 4 sends the control signal to the door lock ECUs 5a to 5d for locking the doors 11 to 14 upon detecting one of the door lock switches 6a2 to 6d2 is operated when the user of the portable device 1 gets out of the automobile 10 after the automobile 10 is parked and the engine is turned off. The electronic key ECU 4 simultaneously controls the engine ECU 8 to put the engine in the immobilized condition.

The doors 11 to 14 may be locked in a different manner. That is, the doors 11 to 14 may have door lock touch sensors or the like instead of having the door lock switches 6a2 to 6d2.

A carrier of the portable device 1, as described above, automatically attains access to the automobile when the automobile is controlled by the door lock system in the present embodiment of the invention.

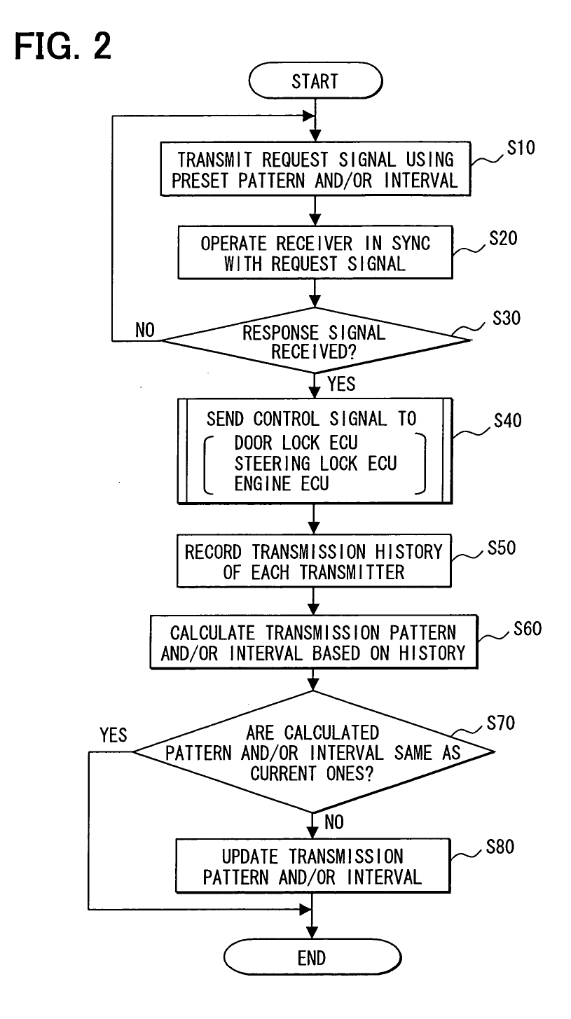

A process for controlling the door lock system of the present embodiment is described with reference to a flowchart shown in FIG. 2. The process in the flowchart in FIG. 2 starts when the automobile 10 is parked, that is, the engine of the automobile 10 is stopped and the doors are locked.

The process starts with step S10 wherein the transmitters 2a to 2d transmit the request signal using a predetermined transmission pattern and interval. The transmission pattern and the transmission interval differ according to the position of the transmitters 2a to 2d, that is, the position of the doors 11 to 14. The transmission pattern and interval of the request signal may be changed based on a frequency of use of each of the doors 11 to 14 in step S70.

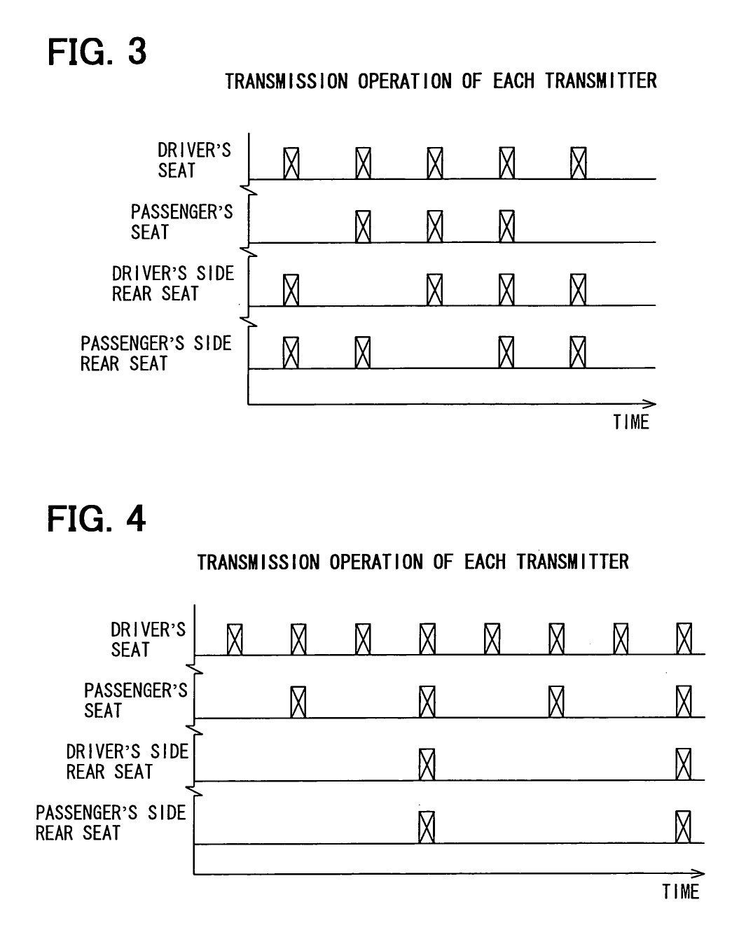

FIGS. 3 and 4 show time charts of the transmission patterns and intervals for each of the transmitters 2a to 2d. Frequency of transmission is lower, that is, the interval between the transmissions is longer, from the transmitters disposed in less frequently used doors.

The exemplary time chart shown in FIG. 3 shows that the transmitter 2a uses a basic pattern of transmission for transmitting the request signal, because the transmitter 2a is disposed in a most frequently used door, that is, the door 11 for a driver's seat, while other transmitters 2b to 2d (disposed in the doors for passenger's seat and other seats) use a modified pattern of transmission for transmitting the request signal. That is, the transmission in the modified transmission pattern less frequently transmits the request signal by skipping the transmission for, for example, once in two transmissions or in three transmissions. In this manner, each of the transmitters 2a to 2d transmits the request signal differently.

The request signal shown in FIG. 4 uses different intervals of transmission for the transmitters 2a to 2d. Frequency of transmission of the request signal may be changed by applying different intervals for different transmitters as shown in FIG. 4.

The transmission of the request signal is preferably most frequent from the transmitter 2a in the door for the driver's seat, and is preferably less frequent from other transmitters by applying different transmission patterns or different transmission intervals. Therefore, an initial setting of the transmission transmits the request signal most frequently from the transmitter 2a and less frequently from the transmitters 2b to 2d. In this manner, energy consumption by the transmission may be suppressed without sacrificing operability when the door lock system is put in use at the beginning of use of the automobile 10.

However, a pattern of use of the doors may vary depending on the user of the portable device 1. Therefore, the initial setting of the transmission may use a same transmission pattern and/or a same transmission interval for all of the transmitters 2a to 2d. The pattern and/or the interval may be changed later in the course of use based on a history of use.

In step S20, the receiver 3 operates for reception of the request signal for a predetermined period of time in synchronization with the transmission of the request signal from the transmitters 2a to 2d. The operation for reception is a limited amount of time for receiving the ACK signal. The operation for reception is extended to further receive the response signal having the ID code from the portable device 1 when the ACK signal is received.

In step S30, reception of the response signal from the portable device 1 is determined. The response signal is determined as “received” when the third response signal including the ID code and the response code is received.

In step S40, various operations are executed based on the reception of the response signal. That is, the electronic key ECU 4 outputs the control signals to the door lock ECUs 5a to 5d, the steering lock ECU 7 and the engine ECU 8 to unlock the door lock, to unlock the steering lock, to give permission to start the engine and the like.

In step S50, the response code in the response signal is checked to identify which transmitter triggered the response signal from the portable device 1 by transmitting the request signal. The identified transmitter is recorded as a history of transmission in a memory of the electronic key ECU 4.

In step S60, the transmission patterns and/or intervals for each of the transmitters 2a to 2d are calculated based on a predetermined number of the history recorded in the memory. The frequencies of the transmission of the request signal in the transmission patterns and/or the transmission intervals are so controlled that the transmitter in frequent use transmits the request signal more frequently than the transmitter in less frequent use.

More practically, the most frequently used transmitter may be set to transmit the request signal most frequently, and the transmission from other transmitters may be equally decreased. The transmission of the request signal may be decreased stepwise towards the least frequently used transmitter. The transmission from the least frequently used transmitter may be stopped.

In step S70, the calculated transmission patterns and/or the transmission intervals are compared with the current pattern or interval. The process for controlling the door lock system concludes when the current pattern and/or the interval are determined as same as the calculated ones. The process proceeds to step S80 when the pattern and/or the interval is determined as different in step S70.

In step S80, the transmission patterns and/or the transmission intervals of each of the transmitters 2a to 2d are updated to the calculated patterns and/or calculated intervals. The transmission is executed based on the calculated patterns and/or intervals after an update.

Each of the users of the portable device 1 tends to use specific doors when he/she approaches the automobile 10. The transmission patterns and/or intervals may reflect a tendency of use of the doors by each of the users. That is, the frequency of transmission from the specific transmitter may be increased to promptly detecting the approaching user. In this manner, the operability of the door lock system is maintained. The frequency of transmission of the request signal from other transmitters is decreased to suppress energy consumption by the station unit on the automobile 10.

The door lock system may not detect the approaching user having the portable device 1 until the user touches one of the door handles 6a to 6d when the transmission from the less frequently used transmitter is stopped. Therefore, the request signal is preferably transmitted from the transmitter in the door being approached by the user upon detecting the door open operation by the user through one of the touch sensors 6a1 to 6d1.

The user of the portable device 1 may enter into the automobile 10 through the door which the user does not usually approach. In this case, the user may not be detected by the bi-directional communication. The above-described scheme of operation enables the bi-directional communication between the portable device 1 and the transmitters 2a to 2d when the user touches the door handles 6a to 6d.

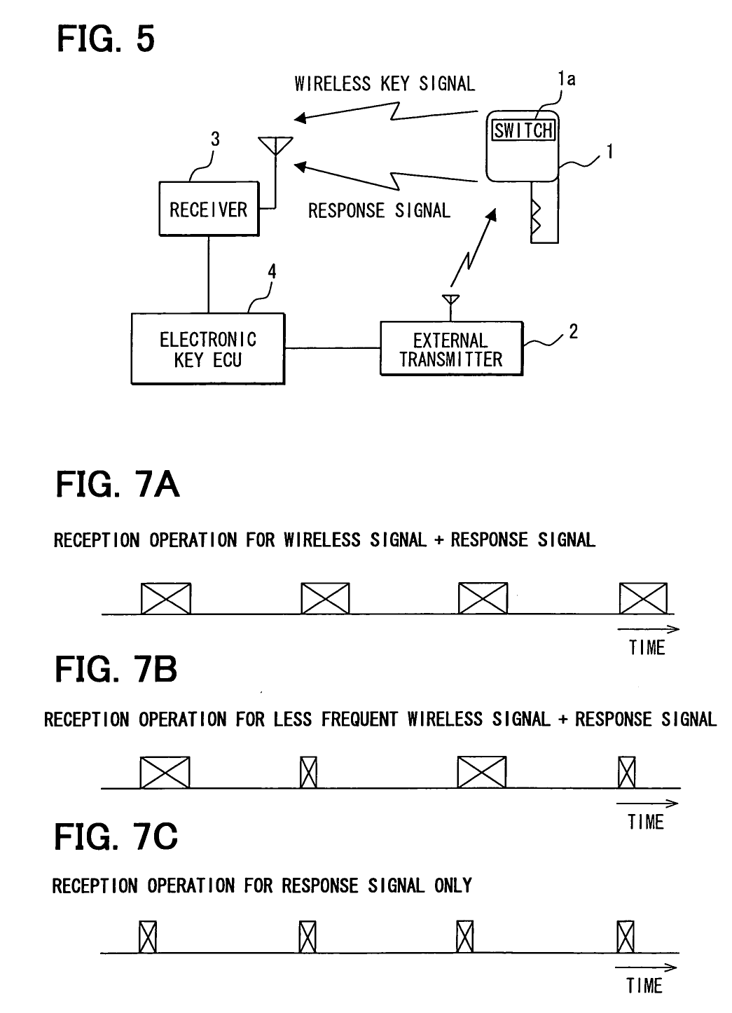

A second embodiment of the present invention is described with reference to the drawings. Difference in a scheme of operation between the first embodiment and the second embodiment is explained based on the block diagram shown in FIG. 5.

The portable device 1 includes a switch 1a for transmitting a lock/unlock signal to the station unit. That is, the door lock system in the present embodiment includes two types of door lock control functions: a first door lock control function that controls conditions of the doors 11 to 14 between a locked state and an unlocked state by a signal from the switch 1a on the portable device 1 (Wireless key function), and a second door lock control function based on the bidirectional communication for exchanging the ID code (Smart key function).

A “wireless key” signal from the switch 1a and the response signal transmitted in response to the request signal from the transmitters 2a to 2d both use a radio frequency. The wireless key signal and the response signal are received by the same receiver 3 on the automobile 10. The other part of the scheme of the present embodiment is the same as the first embodiment.

The receiver 3 is intermittently turned on to receive the wireless key signal and the response signal. The receiver 3 has to receive the wireless key signal including the ID code that is longer than the ACK signal used in the response signal. In this case, the energy consumption by the receiver 3 increases because the receiver 3 has to be kept turned on for a longer period than in the reception operation of the response signal in the first embodiment. The receiver 3 also has to be turned on to pick up the signal from the switch 1a. Thus, the receiver 3 has to be turned on at least once in a certain period. The consumption of energy may increase because of this requirement.

Further, the user of the portable device 1 tends to use only one of the two door lock control functions. Therefore, the receiver 3 may consume the energy in vain when the user rarely uses the wireless key function. The transmitters 2a to 2d may be regarded as a drain of energy when the user rarely uses the smart key function.

The present embodiment decreases the frequency of operation of the transmitters 2a to 2d and the receiver 3 for a rarely used function based on a history of use of the wireless key function and the smart key function.

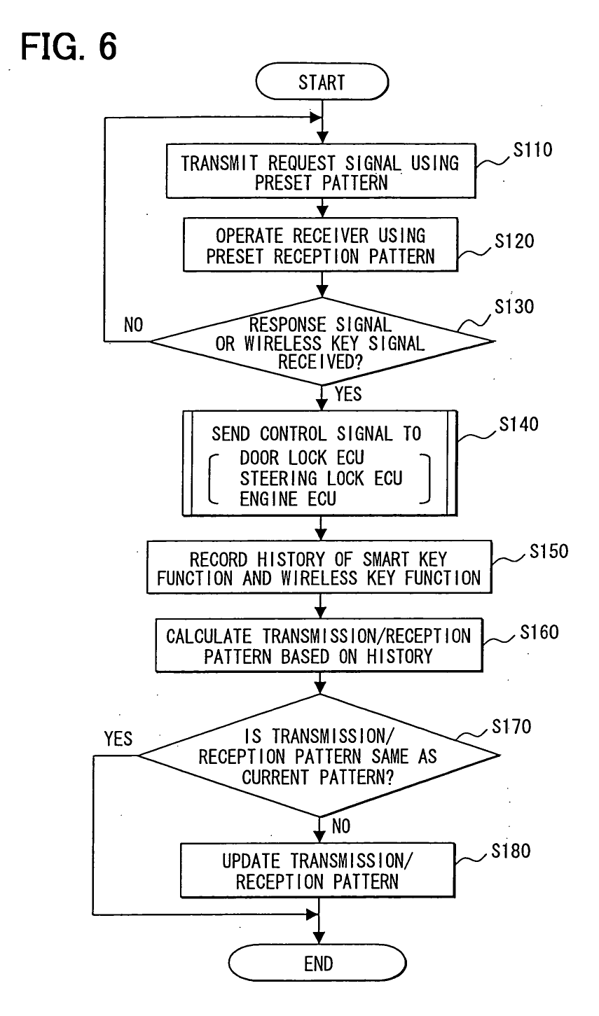

A process for controlling the door lock system of the present embodiment is described with reference to a flowchart shown in FIG. 6. The process in the flowchart in FIG. 6 starts when the automobile 10 is parked, that is, the engine of the automobile 10 is stopped and the doors are locked.

In step S110, an initial pattern of transmission is used to transmit the request signal from the transmitters 2a to 2d. The initial transmission pattern may be changed or may be stopped later based on the history of use of the smart key function.

In step S120, the receiver 3 is turned on based on an initial reception pattern. In step S130, reception of the wireless key signal or the response signal from the portable device 1 is determined. The response signal is determined as “received” when the third response signal including the response code is received as determined in the first embodiment. The wireless key signal is determined as “received” when the signal is received with the ID code contained therein.

In step S140, various operations are executed depending on the received signal. The response signal is processed in the same manner as in the first embodiment. The wireless key signal is processed to control the electronic key ECU 4 for sending control signals to the door lock ECUs 5a to 5d to switch the lock and unlock states of each of the doors 11 to 14. The door lock ECUs 5a to 5d controls the doors based on the control signal.

The portable device 1 may include two different keys for locking and unlocking the doors 11 to 14. In this case, the control signal with an attribute to distinguish a type of the control signal is sent from the electronic key ECU 4 to the door lock ECUs 5a to 5d.

In step S150, the memory in the electronic key ECU 4 is used to record the history of use of the smart key function and the wireless key function. In step S160, a new transmission pattern for the transmitters 2a to 2d with a new reception pattern for the receiver 3 is calculated based on the history of use of the two functions. That is, an optimum transmission operation of the request signal from the transmitters 2a to 2d and an optimum reception operation for the wireless key signal and the response signal by the receiver 3 are calculated.

Examples of the reception operation pattern by the receiver 3 is shown as a time chart in FIGS. 7A to 7C. The pattern in FIG. 7A is, for example, used an initial pattern that intermittently operates the receiver 3 for a longer duration to receive both the wireless key signal and the response signal. In this case, the transmitters 2a to 2d transmit the request signal in synchronization with the operation of the receiver 3.

The pattern in FIG. 7B is used when the wireless key function is less frequently used compared to the smart key function. In this case, the receiver 3 alternates two conditions of reception operation, that is, a reception operation for the wireless key signal and the response signal, and a reception operation for the response signal (ACK signal) only. The receiver 3 extends the reception operation when it received the ACK signal to receive a subsequent signal including the ID code from the portable device 1.

The pattern in FIG. 7C is used when the wireless key function seems to be in rare use. The reception operation in FIG. 7C only receive the response signal (ACK signal).

The patterns in FIGS. 7B and 7C show examples for less frequent use of the wireless key function. The less frequent use of the smart key function can be accommodated by a pattern with a decreased frequency of request signal transmission from the transmitters 2a to 2d.

In step S160, a new pattern for operating the transmitters 2a to 2d and the receiver 3 for transmission and reception is calculated based on the history of use of the smart key function and the wireless key function.

In step S170, the new pattern and the pattern currently in use are compared. The process for controlling the door lock system concludes when the new pattern is determined to be identical with the pattern currently in use. The process proceeds to step S180 when the new pattern is different from the pattern currently in use. In step S180, the pattern is updated by the new pattern calculated in step S160.

The door lock system of the present embodiment using the above-described scheme of operation controls conditions of the door locks in the doors 11 to 14 in a less energy consuming manner by operating rarely used portion of the system less frequently. That is, the wireless key function that enables the user of the portable device 1 to send the control signal through switch operation for controlling the door locks and/or the smart key function that uses bidirectional communication for controlling the door lock are optimized in terms of operation frequency to achieve the decreased energy consumption by the station unit in the automobile 10.

In addition, as described in the first embodiment, the request signal may preferably be sent from one of the transmitters 2a to 2d to which the user is approaching when the door open operation on at least one of the doors 11 to 14 is detected by the touch sensors 6a1 to 6d1 on the door handles 6a to 6d without receiving the response signal from the portable device 1.

Although the present invention has been fully described in connection with the preferred embodiments thereof with reference to the accompanying drawings, it is to be noted that various changes and modifications will become apparent to those skilled in the art.

For example, the control process described in the first embodiment and the control process in the second embodiment may be combined as one embodiment.

Such changes and modifications are to be understood as being within the scope of the present invention as defined by the appended claims.

What is claimed is:

1. A remote control system for controlling accessibility of an automobile comprising:
at least one door lock;
a transmitter in each of at least two doors on the automobile for transmitting a request signal;
a portable device for transmitting a response signal having an identification code in a response to the request signal;
a receiver for receiving the response signal; and
a controller for controlling the door lock based on a comparison of the identification code with a registered code,
wherein each transmitter transmits the request signal in a specific interval that reflects a usage of each door.

2. A remote control system for controlling accessibility of an automobile comprising:
at least one door lock;
a transmitter in each of at least two doors on the automobile for transmitting a request signal;
a portable device for transmitting a response signal having an identification code in a response to the request signal;
a receiver for receiving the response signal; and
a controller for controlling the door lock based on a comparison of the identification code with a registered code,
wherein the controller identifies the transmitter that transmitted the request signal based on the response signal received by the receiver,
the controller records information on the identified transmitter as a history of use, and
the controller controls the transmitter in less frequent use to transmit the request signal less frequently based on the history of use.

3. The remote control system of claim 2,
wherein the controller controls the transmitter in frequent use to transmit the request signal in a first interval,
the controller controls the transmitter in less frequent use to transmit the request signal in a second interval, and
the controller sets the second interval longer than the first interval.

4. The remote control system of claim 2,
wherein the controller stops transmission operation of the transmitter in less frequent use.

5. The remote control system of claim 1 further comprising;
an operation switch disposed on each of the at least two doors for detecting a user of the portable device,
wherein the controller identifies the operation switch being operated by the user when the user operated the operation switch without transmitting the response signal from the portable device to the receiver, and
the controller controls the transmitter in the door having the identified operation switch to transmit the request signal upon detecting the user.

6. A remote control system for controlling access to an automobile comprising;
at least one door lock;
a station unit configured for mounting in the automobile to control the door lock;
a portable device for transmitting a first signal in a response to a user operation and a second signal in a response to a request signal;
the station unit having:
a transmitter for intermittently transmitting the request signal to the portable device;
a receiver for receiving the first signal and the second signal from the portable device; and
a controller for controlling the door lock,
wherein the receiver intermittently operates in a first interval for receiving the first signal,
the receiver operates in synchronization with transmission operation of the request signal for receiving the second signal,
the controller records use of the first signal and the second signal as a history of use, and
the controller controls the transmitter and/or the receiver so that one of reception operation by the receiver for receiving the first signal and reception operation by the receiver in synchronization with transmission operation of the request signal by the transmitter for receiving the second signal is performed less frequently than the other based on the history of use of the first signal and the second signal.

7. The remote control system of claim 6 further comprising:
an operation switch disposed on each of the at least two doors for detecting a user of the portable device,
wherein the controller controls the transmitter in the door to transmit the request signal upon detecting the user by the operation switch when the user operates the operation switch without transmitting the second signal from the portable device to the receiver.

8. A method of remotely controlling an automobile door lock system using a request signal transmitted from a transmitter disposed in each of a plurality of doors and a response signal transmitted in response to the request signal from a portable device, comprising a steps of:
providing at least one door lock in the door;
using a receiver on the automobile for receiving the response signal;
confirming an identification code in the response signal with a registered code in the system; and
controlling each transmitter to transmit the request signal in a specific interval.

9. A method of remotely controlling an automobile door lock system using a request signal transmitted from a transmitter disposed in each of a plurality of doors and a response signal transmitted in response to the request signal from a portable device, comprising a steps of:
providing at least one door lock in the door;
using a receiver on the automobile for receiving the response signal;
confirming an identification code in the response signal with a registered code in the system;
recording information on use of the transmitter as a history when the receiver receives the response signal; and
controlling less frequently used transmitter to transmit the request signal less frequently based on the history.

10. The method according to claim 9 further comprising the steps of,
providing an operation switch on each of the plurality of the doors;
detecting a user of the portable device by the operation switch; and
transmitting the request signal upon detection of the user when the receiver has not received the response signal from the portable device.

11. A method of remotely controlling an automobile door lock system using a request signal transmitted from a transmitter disposed in a door, a response signal transmitted in response to the request signal from a portable device and an operation signal for operating a door lock, comprising a steps of:
providing at least one door lock in the door;
using a receiver for receiving the response signal and the operation signal;
recording information on use of the response signal and use of the operation signal as a history when the receiver receives the response signal and the operation signal; and
decreasing frequently of one of operation of the receiver for receiving the response signal in synchronization with transmission of the request signal by the transmitter and operation of the receiver for receiving the operation signal based on the history.

12. The method according to claim 11 further comprising the steps of:
providing an operation switch on the door;
detecting a user of the portable device by the operation switch; and
transmitting the request signal upon detection of the user when the receiver has not received the response signal from the portable device.
